(19) United States
(12) Patent Application Publication
(10) Pub. No.: US 2004/0080536 A1
(43) Pub. Date: Apr. 29, 2004

(54) Method and user interface for interactive visualization and analysis of microarray data and other data, including genetic, biochemical, and chemical data

(76) Inventors: Zohar Yakhini, Ramat Hasharon (IL); Anya Tslanko, Chicago, IL (US); Amir Ben-Dor, Bellevue, WA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/279,508

(22) Filed: Oct. 23, 2002

(51) Int. Cl. G09G 5/00

(52) U.S. Cl. 345/764

(57) ABSTRACT

An interactive user interface that allows a user to display microarray data, and other data, including genetic, biochemical, and chemical data, in various ways to facilitate human analysis of the displayed data within the context of the genetic, biochemical, chemical, or other experiments from which the data is obtained. The interactive user interface displays processed microarray data as a color-coded, two-dimensional visual array. A user may selectively display textual and numerical annotations for the data on a row basis, a column basis, and on a cell basis. The user interface provides a user with the ability to rank and sort data on a row basis, as well as the ability to partition columns into meaningful groups. The interactive user interface provides for cropping displayed data to focus on data considered to be more significant within the context of a particular analysis. The interactive user interface also allows the color-coded display to be scaled over all display data, or individually scaled on a per-row basis. The interactive user interface allows a researcher to modify ranking, partitioning, scaling, and other parameters of the display in real time, in order to visually explore and navigate various different relationships and correlations between individual data array.

### TECHNICAL FIELD

The present invention relates to the display of data to a user of a computer system and, in particular, to a user interface running on a computer system that provides convenient, interactive display of gene-expression data obtained from one or more microarrays, SNP genotyping data, comparative genome hybridization data, and as well as other types of biological, genetic, biochemical, and chemical data.

### BACKGROUND OF THE INVENTION

The present invention is related to display of molecular-array data, also referred to as microarray data, and other types of genetic, biochemical, and chemical data. A molecular-array-data-based embodiment is discussed, in detail, below. Therefore, a general background of molecular-array technology applied, in particular, to nucleic acid assays, is provided in this section.

Array technologies have gained prominence in biological research and are likely to become important and widely used diagnostic tools in the healthcare industry. Currently, molecular-array techniques, also referred to as microarray techniques, are most often used to determine the concentrations of particular nucleic-acid polymers in complex sample solutions. Molecular-array-based analytical techniques are not, however, restricted to analysis of nucleic acid solutions, but may be employed to analyze complex solutions of any type of molecule that can be optically or radiometrically scanned and that can bind with high specificity to complementary molecules synthesized within, or bound to, discrete features on the surface of an array. Because arrays are widely used for analysis of nucleic acid samples, the following background information on arrays is introduced in the context of analysis of nucleic acid solutions following a brief background of nucleic acid chemistry.

Deoxyribonucleic acid (“DNA”) and ribonucleic acid (“RNA”) are linear polymers, each synthesized from four different types of subunit molecules. The subunit molecules for DNA include: (1) deoxy-adenosine, abbreviated “A,” a purine nucleoside; (2) deoxy-thymidine, abbreviated “T,” a pyrimidine nucleoside; (3) deoxy-cytosine, abbreviated “C,” a pyrimidine nucleoside; and (4) deoxy-guanosine, abbreviated “G,” a purine nucleoside. The subunit molecules for RNA include: (1) adenosine, abbreviated “A,” a purine nucleoside; (2) uracil, abbreviated “U,” a pyrimidine nucleoside; (3) cytosine, abbreviated “C,” a pyrimidine nucleoside; and (4) guanosine, abbreviated “G,” a purine nucleoside. FIG. 1 illustrates a short DNA polymer 100, called an oligomer, composed of the following subunits: (1) deoxyadenosine 102; (2) deoxy-thymidine 104; (3) deoxy-cytosine 106; and (4) deoxyguanosine 108. When phosphorylated, subunits of DNA and RNA molecules are called “nucleotides” and are linked together through phosphodiester bonds 110-115 to form DNA and RNA polymers. A linear DNA molecule, such as the oligomer shown in FIG. 1, has a 5′ end 118 and a 3′ end 120. A DNA polymer can be chemically characterized by writing, in sequence from the 5′ end to the 3′ end, the single letter abbreviations for the nucleotide subunits that together compose the DNA polymer. For example, the oligomer 100 shown in FIG. 1 can be chemically represented as “ATCG.” A DNA nucleotide comprises a purine or pyrimidine base (e.g. adenine 122 of the deoxy-adenylate nucleotide 102), a deoxy-ribose sugar (e.g. deoxy-ribose 124 of the deoxy-adenylate nucleotide 102), and a phosphate group (e.g. phosphate 126) that links one nucleotide to another nucleotide in the DNA polymer. In RNA polymers, the nucleotides contain ribose sugars rather than deoxy-ribose sugars. In ribose, a hydroxyl group takes the place of the 2′ hydrogen 128 in a DNA nucleotide. RNA polymers contain uridine nucleosides rather than the deoxy-thymidine nucleosides contained in DNA. The pyrimidine base uracil lacks a methyl group (130 in FIG. 1) contained in the pyrimidine base thymine of deoxy-thymidine.

The DNA polymers that contain the organization information for living organisms occur in the nuclei of cells in pairs, forming double-stranded DNA helixes. One polymer of the pair is laid out in a 5′ to 3′ direction, and the other polymer of the pair is laid out in a 3′ to 5′ direction. The two DNA polymers in a double-stranded DNA helix are therefore described as being anti-parallel. The two DNA polymers, or strands, within a double-stranded DNA helix are bound to each other through attractive forces including hydrophobic interactions between stacked purine and pyrimidine bases and hydrogen bonding between purine and pyrimidine bases, the attractive forces emphasized by conformational constraints of DNA polymers. Because of a number of chemical and topographic constraints, double-stranded DNA helices are most stable when deoxy-adenylate subunits of one strand hydrogen bond to deoxy-thymidylate subunits of the other strand, and deoxy-guanylate subunits of one strand hydrogen bond to corresponding deoxy-cytidilate subunits of the other strand.

FIGS. 2A-B illustrates the hydrogen bonding between the purine and pyrimidine bases of two anti-parallel DNA strands. FIG. 2A shows hydrogen bonding between adenine and thymine bases of corresponding adenosine and thymidine subunits, and FIG. 2B shows hydrogen bonding between guanine and cytosine bases of corresponding guanosine and cytosine subunits. Note that there are two hydrogen bonds 202 and 203 in the adenine/thymine base pair, and three hydrogen bonds 204-206 in the guanosine/cytosine base pair, as a result of which GC base pairs contribute greater thermodynamic stability to DNA duplexes than AT base pairs. AT and GC base pairs, illustrated in FIGS. 2A-B, are known as Watson-Crick (“WC”) base pairs.

Two DNA strands linked together by hydrogen bonds forms the familiar helix structure of a double-stranded DNA helix. FIG. 3 illustrates a short section of a DNA double helix 300 comprising a first strand 302 and a second, anti-parallel strand 304. The ribbon-like strands in FIG. 3 represent the deoxyribose and phosphate backbones of the two anti-parallel strands, with hydrogen-bonding purine and pyrimidine base pairs, such as base pair 306, interconnecting the two strands. Deoxy-guanylate subunits of one strand are generally paired with deoxy-cytidilate subunits from the other strand, and deoxy-thymidilate subunits in one strand are generally paired with deoxy-adenylate subunits from the other strand. However, non-WC base pairings may occur within double-stranded DNA.

Double-stranded DNA may be denatured, or converted into single stranded DNA, by changing the ionic strength of the solution containing the double-stranded DNA or by raising the temperature of the solution. Single-stranded DNA polymers may be renatured, or converted back into DNA duplexes, by reversing the denaturing conditions, for example by lowering the temperature of the solution containing complementary single-stranded DNA polymers. During renaturing or hybridization, complementary bases of anti-parallel DNA strands form WC base pairs in a cooperative fashion, leading to reannealing of the DNA duplex. Strictly A-T and G-C complementarity between anti-parallel polymers leads to the greatest thermodynamic stability, but partial complementarity including non-WC base pairing may also occur to produce relatively stable associations between partially-complementary polymers. In general, the longer the regions of consecutive WC base pairing between two nucleic acid polymers, the greater the stability of hybridization between the two polymers under renaturing conditions.

The ability to denature and renature double-stranded DNA has led to the development of many extremely powerful and discriminating assay technologies for identifying the presence of DNA and RNA polymers having particular base sequences or containing particular base subsequences within complex mixtures of different nucleic acid polymers, other biopolymers, and inorganic and organic chemical compounds. One such methodology is the microarray-based hybridization assay. FIGS. 4-7 illustrate the principle of the microarray-based hybridization assay. A microarray (402 in FIG. 4) comprises a substrate upon which a regular pattern of features is prepared by various manufacturing processes. The microarray 402 in FIG. 4, and in subsequent FIGS. 5-7, has a grid-like 2-dimensional pattern of square features, such as feature 404 shown in the upper left-hand corner of the microarray. Each feature of the microarray contains a large number of identical oligonucleotides covalently bound to the surface of the feature. These bound oligonucleotides are known as probes. In general, chemically distinct probes are bound to the different features of a microarray, so that each feature corresponds to a particular nucleotide sequence. In FIGS. 4-6, the principle of microarray-based hybridization assays is illustrated with respect to the single feature 404 to which a number of identical probes 405-409 are bound. In practice, each feature of the microarray contains a high density of such probes but, for the sake of clarity, only a subset of these are shown in FIGS. 4-6.

Once a microarray has been prepared, the microarray may be exposed to a sample solution of target DNA or RNA molecules (410-413 in FIG. 4) labeled with fluorophores, chemiluminescent compounds, or radioactive atoms 415-418. Labeled target DNA or RNA hybridizes through base pairing interactions to the complementary probe DNA, synthesized on the surface of the microarray. FIG. 5 shows a number of such target molecules 502-504 hybridized to complementary probes 505-507, which are in turn bound to the surface of the microarray 402. Targets, such as labeled DNA molecules 508 and 509, that do not contain nucleotide sequences complementary to any of the probes bound to the microarray surface do not hybridize to generate stable duplexes and, as a result, tend to remain in solution. The sample solution is then rinsed from the surface of the microarray, washing away any unbound-labeled DNA molecules. In other embodiments, unlabeled target sample is allowed to hybridize with the microarray first. Typically, such a target sample has been modified with a chemical moiety that will react with a second chemical moiety in subsequent steps. Then, either before or after a wash step, a solution containing the second chemical moiety bound to a label is reacted with the target on the microarray. After washing, the microarray is ready for scanning. Biotin and avidin represent an example of a pair of chemical moieties that can be utilized for such steps.

Finally, as shown in FIG. 6, the bound labeled DNA molecules are detected via optical or radiometric scanning. Optical scanning involves exciting labels of bound labeled DNA molecules with electromagnetic radiation of appropriate frequency and detecting fluorescent emissions from the labels, or detecting light emitted from chemiluminescent labels. When radioisotope labels are employed, radiometric scanning can be used to detect the signal emitted from the hybridized features. Additional types of signals are also possible, including electrical signals generated by electrical properties of bound target molecules, magnetic properties of bound target molecules, and other such physical properties of bound target molecules that can produce a detectable signal. Optical, radiometric, or other types of scanning produce an analog or digital representation of the microarray as shown in FIG. 7, with features to which labeled target molecules are hybridized similar to 706 optically or digitally differentiated from those features to which no labeled DNA molecules are bound. In other words, the analog or digital representation of a scanned microarray displays positive signals for features to which labeled DNA molecules are hybridized and displays negative features to which no, or an undetectably small number of, labeled DNA molecules are bound. Features displaying positive signals in the analog or digital representation indicate the presence of DNA molecules with complementary nucleotide sequences in the original sample solution. Moreover, the signal intensity produced by a feature is generally related to the amount of labeled DNA bound to the feature, in turn related to the concentration, in the sample to which the microarray was exposed, of labeled DNA complementary to the oligonucleotide within the feature.

Once the labeled target molecule has been hybridized to the probe on the surface, the microarray may be scanned by an appropriate technique, such as by optical scanning in cases where the labeling molecule is a fluorophore or by radiometric scanning in cases where the signal is generated through a radioactive decay of labeled target. In the case of optical scanning, each different wavelength at which a microarray is scanned produces a different signal. Scanning of a feature by an optical scanning device or radiometric scanning device generally produces a scanned image comprising a rectilinear grid of pixels, with each pixel having a corresponding signal intensity. These signal intensities are processed by a microarray-data-processing program that analyzes data scanned from a microarray to produce experimental or diagnostic results which are stored in a computer-readable medium, transferred to an intercommunicating entity via electronic signals, printed in a human-readable format, or otherwise made available for further use. Processed molecular-array data is commonly stored within a computer system in a two-dimensional array, or other similar data structure, in which the signal intensities of microarray features can be conveniently stored, indexed, and retrieved.

Once the signal intensity data is stored within a data array, or other data structure, within a computer system, the data can be copied to files or printed out on paper to allow a researcher or other system user to analyze the data within the context of the genetic, biochemical, or chemical experiment from which the data was ultimately obtained. However, it is relatively difficult for a researcher or other user to quickly and conveniently discern genetic, biochemical, and chemical significance from rows and columns of numbers. Therefore, the data stored in a two-dimensional array or other convenient data structure is normally displayed graphically on a computer screen to a researcher or other user.

FIG. 8 illustrates display of molecular-array data contained within a two-dimensional data array 802 as a color-coded, graphical array 804 displayed on a computer screen 806. In currently available molecular-array-data display systems, the molecular-array-data stored within the data structure, such as two-dimensional data array 802, is directly mapped into a corresponding graphical array 804. The data contained within each cell of the data structure 802 is mapped to a color and/or color intensity that is displayed to the user in the corresponding cell of the graphical array 804. Rather than attempting to read and correlate lists or tables of numbers, a user can quickly scan the graphical array 804 to detect patterns of signal intensities and visually correlate those patterns with patterns of gene expression or other genetic, biochemical, or chemical phenomenon discernable from the molecular-array data.

While currently available, computer-based visualization tools have greatly facilitated human-user analysis of molecular-array data, that analysis may still be quite difficult and time consuming for a variety of reasons. Considering gene-expression-level experiments, for example, the color and color intensities displayed in a graphical array, such as graphical array 804, may rather directly correlate to the expression levels of corresponding genes within an organism. However, a human user generally does not know, a priori, exactly what expression-level patterns to expect. Thus, the data may not be organized within the data array 802 in a way that facilitates discovery of multi-gene expression-level patterns. For example, a subset of genes may be up-regulated, a subset of genes may be down-regulated, and the expression levels of other genes may be invariant or vary in more complex fashions during a series of experiments. Unless a human user knows, beforehand, what expression-level patterns to expect and organizes the stored data to correspond to the expression-level patterns, visual display of the molecular-array data stored in data array 802 will often present to the human user a bewildering, seemingly random, pattern of colors and color intensities. In order to make sense of the data, a human user needs to tediously and painstakingly compare the color intensities of different combinations of rows and columns in the graphical array 804. Additional problems include the inability of a human user to interactively partition molecular-array data into meaningful subgroups, to rank and sort data, and to apply various different scaling techniques to enhance the visual display in genetically, biochemically, and chemically meaningful ways. Many other types of complex genetic, biochemical, and chemical data also need to be displayed, in meaningful ways, to biomedical researchers, diagnosticians, chemists, biochemists, and others. In most cases, the problem of displaying such data is similar to the above-described problems attendant with display of molecular array data. Developers and manufacturers of molecular-array-data processing and display systems, and users of such processing and display systems, have thus recognized a need for a more convenient, interactive, and scientifically meaningful user interface for the display of molecular-array data, and other types of data, including genetic, biochemical, and chemical data.

### SUMMARY OF THE INVENTION

The present invention provides an interactive user interface that allows a user to display microarray data, and other complex genetic, biochemical, and chemical data, in various ways to facilitate human analysis of the displayed data within the context of the genetic, biochemical, chemical, or other experiments from which the data is obtained. One embodiment of the present invention is a user interface for displaying gene expression data. The interactive user interface displays processed gene-expression data in a color-coded, two-dimensional visual data array. In addition, a user may display textual and numerical annotations for the data, both on a row and column basis, as well as on a cell basis. The user interface provides a user with the ability to rank and sort data on a row basis, as well as the ability to partition the data into meaningful groups on a column basis. In an alternative embodiment, rows may be partitioned, and columns ranked and sorted. The interactive user interface provides for cropping data to focus on data considered to be more significant within the context of a particular analysis. The interactive user interface also allows the color-coded display of expression levels, or signal intensities, to be scaled over all display data, or individually scaled on a per-row basis. The interactive user interface allows a user to modify ranking, partitioning, scaling, and other parameters of the display in real time, in order to visually explore and navigate various different relationships and correlations between individual data, recognizing correlations and relationships as patterns of color in the displayed cells of the visual data array.

### BRIEF DESCRIPTION OF THE DRAWINGS

FIG. 1 illustrates a short DNA polymer.

FIG. 2A shows hydrogen bonding between adenine and thymine bases of corresponding adenosine and thymidine subunits.

FIG. 2B shows hydrogen bonding between guanine and cytosine bases of corresponding guanosine and cytosine subunits.

FIG. 3 illustrates a short section of a, DNA double helix.

FIGS. 4-7 illustrate the principle of array-based hybridization assays.

FIG. 8 illustrates display of molecular-array data contained within a two-dimensional data array as a color-coded, visual data array displayed on a computer screen.

FIG. 9 illustrates the breadth of data sets that may be effectively displayed using the techniques of the present invention.

FIG. 10 illustrates one alternative for generating a RAW_DATA array using data obtained from a number of different molecular-array experiments.

FIG. 11 shows an example display of a 32-row×20-column RAW_DATA array.

FIG. 12 illustrates row-based, column-based, and cell-based annotation of the data displayed in a visual data array.

FIG. 13 illustrates column partitioning of the visual data array.

FIGS. 14A-C illustrate one possible user-interface dialogue for partitioning and reordering the columns of a visual data array.

FIG. 15 illustrates row reordering of a visual data array.

FIG. 16 shows a simple dialogue box that allows a researcher or other user to reorder rows within a visual data array.

FIG. 17 shows display of curves fit to data corresponding to partitions “X,” “Y,” and “Z” for the first row of the row-ranked-and-partitioned visual data array shown in FIG. 15.

FIG. 18 shows a simple, slidable control for altering the number of rows displayed in a visual data array.

FIG. 19 illustrates display of the twenty-one most significant rows from the row-ranked-and-partitioned visual data array.

FIG. 20 represents selection by a user of a small region of a visual data array for display at higher magnification.

FIG. 21 shows display of the selected region in FIG. 20 following input of a mouse click or other user input.

FIG. 22 shows two adjacent rows within a visual data array.

FIG. 23 illustrates the two adjacent rows shown in FIG. 22 following row-based rescaling of displayed colors.

FIG. 24 illustrates a simple dialogue box that may be provided to allow a user to select common scaling or row-by-row scaling, and to select different methods for scaling displayed colors to data values.

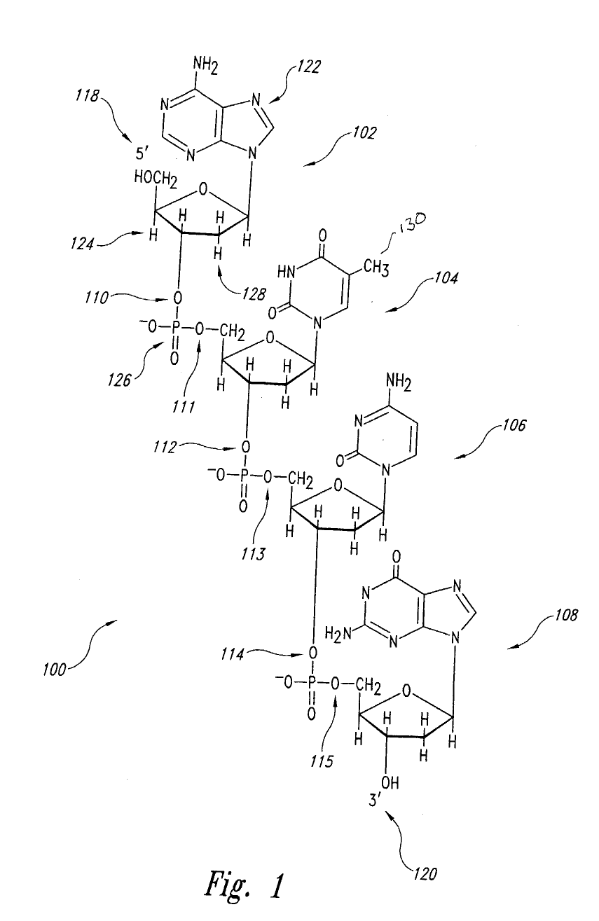

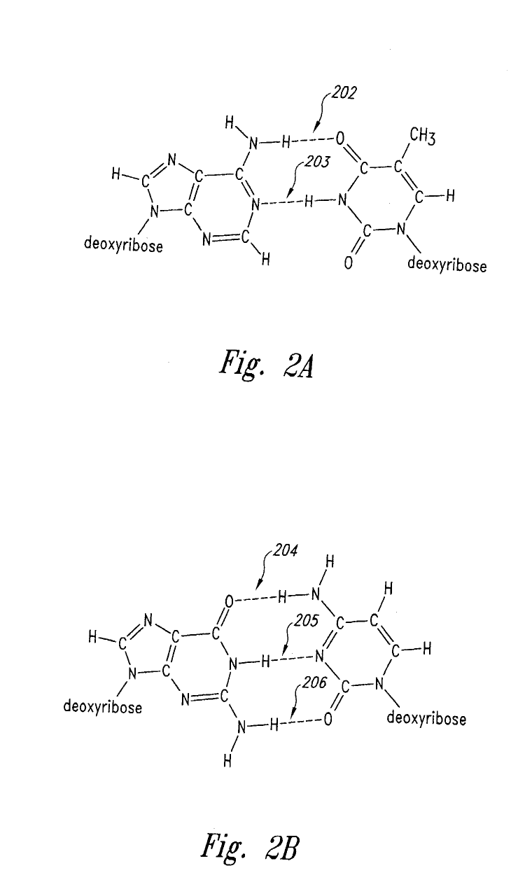

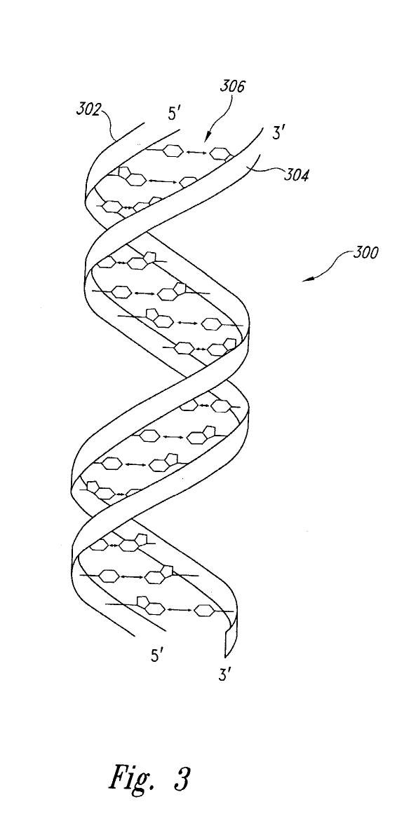

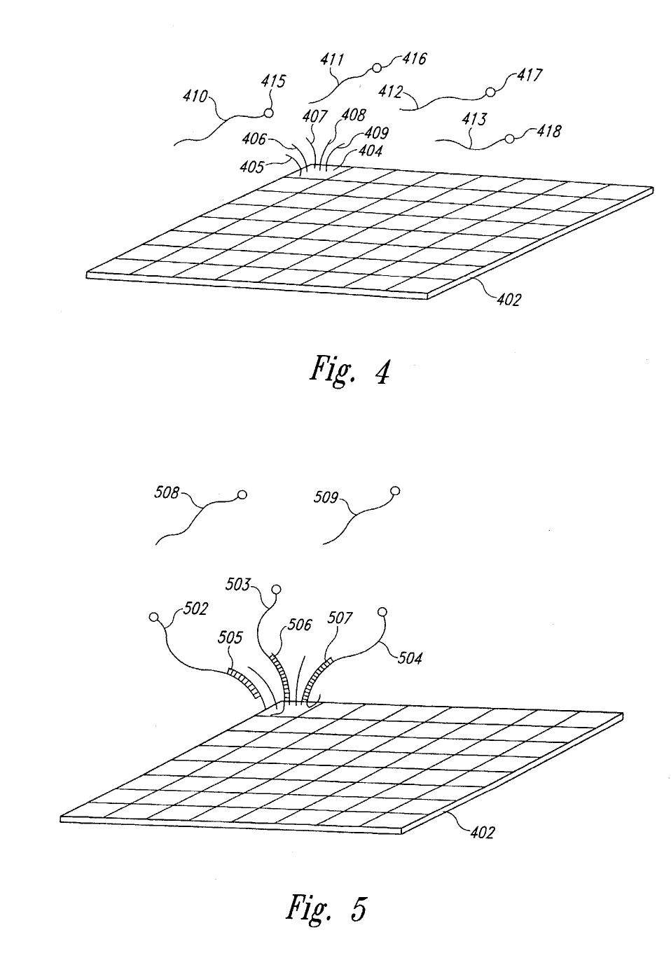

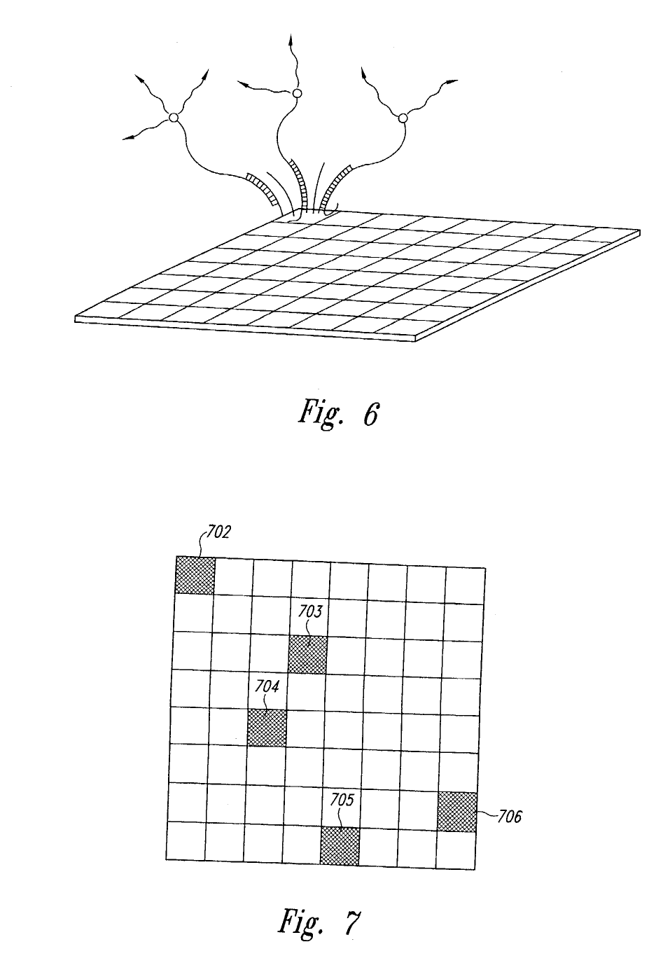

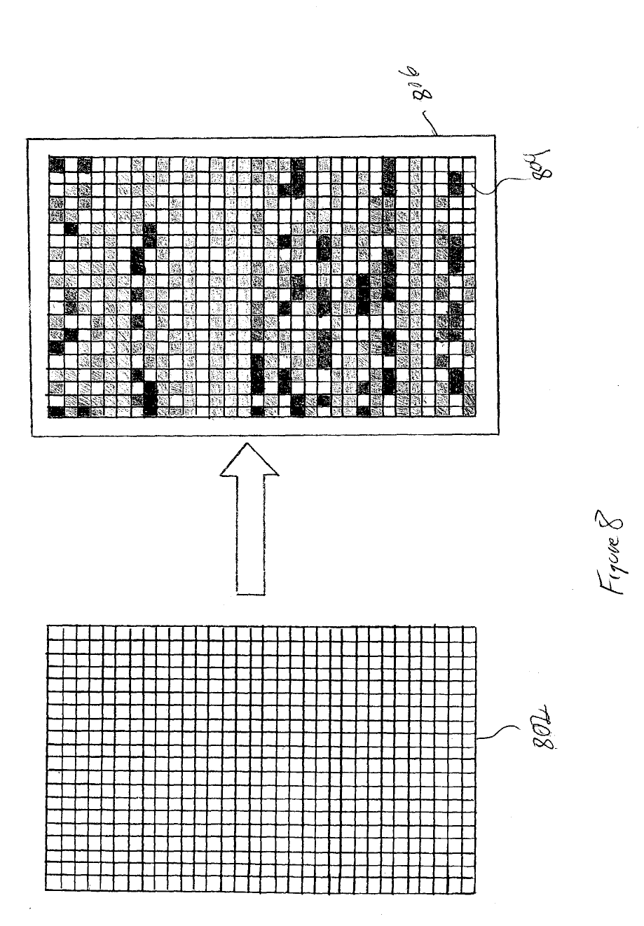

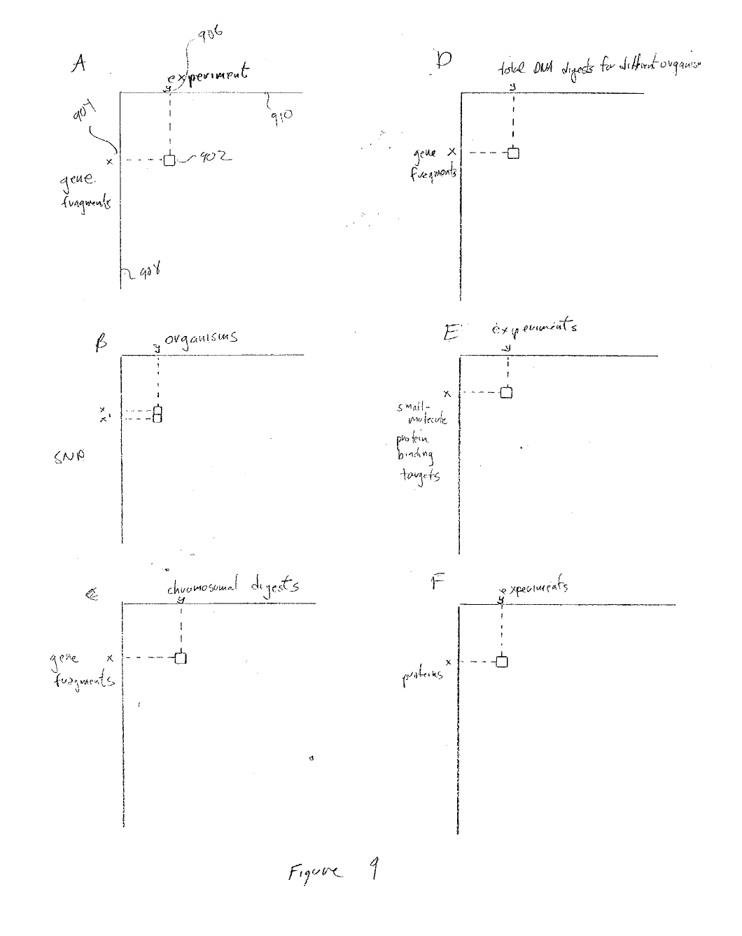

### DETAILED DESCRIPTION OF THE INVENTION

One embodiment of the present invention relates to display of gene-expression data derived from microarray experiments. In the following discussion, the interactive graphical user interface (“IGUI”) that represents one embodiment of the present invention is described in terms of data obtained in gene-expression experiments. The processed microarray data provides a numerical measure of the expression levels of individual genes. The probes of the corresponding microarrays may target mRNA gene transcripts in order to measure the concentration of gene transcript MRNA in a tissue sample, or may alternatively target the translation products of the mRNA transcripts, including soluble proteins. Many other types of molecular-array data may also be interactively manipulated using the IGUI of the present invention. For example, molecular-array probes may target the active sites of enzymes, and the molecular-array assays may be designed to measure enzyme activities. As another example, molecular array probes may be antigens or enzymes that specifically bind to particular environmental toxins, and the molecular-array assay may be intended to measure the concentrations of environmental toxins in sample solutions.

FIGS. 9A-F shows 2-dimensional representations of various types of genetic and biochemical data that may be displayed using the IGUI that represents one embodiment of the present invention. FIG. 9 illustrates the breadth of data sets that may be effectively displayed using the techniques of the present invention. For example, gene-expression may be displayed as a two-dimensional array of data points, as shown in FIG. 9A, with each data point, such as data point 902, representing the expression level of a gene x 904 in an organism y 906, where the vertical, x-axis 908 represents different gene-fragment microarray probes and the y-axis 910 represents different microarray-based experiments. For example, each experiments may be a microarray-based analysis of a different tissue type, the same tissue type at a particular point in time, or a tissue type in a particular organism. As shown in FIG. 9B, single-nucleotide polymorphism (SNP) data may similarly be displayed in a two-dimensional array of data points, in which a pair of vertical data points represents the presence or absence of a particular SNP comprising sequences x and x′ in a organism y. Such a display allows for rapid SNP genotyping of a number of organisms, each of which may have the genotype aa, aA, or AA for an SNP pair a and A. Similarly, as shown in FIG. 9C, comparative genome-hybridization data may similarly be displayed in a two-dimensional array of data points, with each data point corresponding to the number of copies of a particular gene x in the digest of a particular chromosome or set of chromosomes y, or, as shown in FIG. 9D, comparative genome-hybridization data may be displayed in a two-dimensional array of data points, with each data point corresponding to the number of copies of a particular gene x in the total genomic digest of a particular organism y. As shown in FIG. 9E, small-molecule-array data may be displayed in a two-dimensional array of data points, with each data point corresponding to whether or not a labeled protein molecule in an experiment y binds to a particular small-molecule protein binding target x. As a final example, as shown in FIG. 9F, protein-array data may be displayed in a two-dimensional array of data points, with each data point corresponding to whether a labeled small molecule in an experiment y binds to a particular protein x. There are an almost limitless number of additional examples of biological and chemical data that may be profitably displayed in two-dimensional data arrays.

Continuing with a gene-expression-data example, the IGUI that represents one embodiment of the present invention displays molecular-array data that is stored in a two-dimensional data array referred to as a RAW_DATA array. Data obtained from many different individual molecular arrays can be combined together and stored within a single RAW_DATA array, and may be organized within the RAW_DATA array in accordance with a logical data-storage scheme that reflects the underlying meaning and organization of the experiments from which the data is obtained. Textual annotations for the data stored in a RAW_DATA array may be directly incorporated within the RAW_DATA array, in various text-based fields, or may be separately stored in files or data structures in a way that the annotations can be correlated with data in the RAW_DATA array.

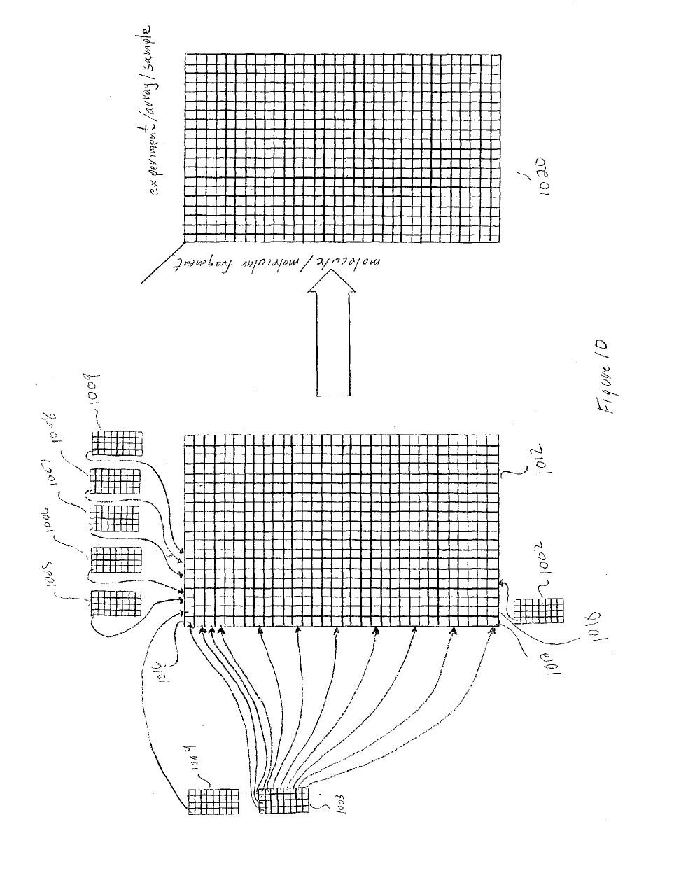

FIG. 10 illustrates one alternative for generating a RAW_DATA array using data obtained from a number of different molecular-array experiments. In FIG. 10, the data obtained from individual microarrays is represented by the small arrays 1002-1009. Each microarray may measure gene expression levels, or the concentrations of other types of molecules, in various different biological samples. As one example, a series of identical microarrays may be exposed to tissue samples from an organism to analyze differences in gene expression within the different tissues. As another example, a series of tissue samples may be taken from an organism over time, in order to monitor fluctuation of gene expression levels over time within the organism. One of a number of identical microarrays may be exposed to each tissue sample, so that the fluctuations and expression of a particular gene may be directly determined from the signal intensities of a particular feature of the number of microarrays exposed to tissue samples. In these cases, it is convenient to map the signal intensities obtained from each microarray into columns of a larger, aggregate data array. For example, as shown in FIG. 10, the signal intensities measured for features of microarray 1003 are stored in the first column 1010 of a larger aggregate data array 1012. Feature 0,0 (1014 in FIG. 10) is stored in aggregate array cell (0,0) (1016 in FIG. 10), and successive signal intensity data from successive features in the first row of microarray 1003 are stored in aggregate data array cells (1,0), (2,0), and (3,0). The signal intensity data obtained from microarray 1004 is stored in the second column 1018 of the aggregate data array 1012. Likewise, the signal intensity data obtained from the remaining microarrays shown in FIG. 10 are stored in subsequent columns of the aggregate data array. The data in the aggregate data array can then be processed, organized, and transferred to, or transformed into, a RAW_DATA array 1020, or may be considered to be a RAW_DATA array without further processing. As mentioned in a previous section, more than one data value may be read from each feature of a microarray, and different types of data values may be stored in successive columns of the aggregate data array and/or RAW_DATA array.

The data within the RAW_DATA data array can be organized in many different ways depending on the genetic, biochemical, or chemical meaning of the experiments from which the data was obtained, the structure of the microarrays which generated the data, and other factors. Organization of the data within the RAW_DATA array may be specified in various different ways by users and researchers. Molecular-array data processing and initial storage organization are thus essentially arbitrary and are outside the scope of the present invention.

In describing the present invention, it is convenient to consider a particular organization for the data in the RAW_DATA array, as illustrated in FIG. 10. Assuming that the individual microarrays 1002-1009 are identical, and contain probes targeted to the mRNA transcription products of particular genes, then each microarray represents the measurement of gene expression levels within a particular sample solution for a particular set of genes. As discussed above, the data for each microarray are entered into a particular column of the aggregate data array 1012. This data may then be processed to produce the RAW_DATA array 1020.

In the described organizational scheme, the values in a given row represent the expression levels for one particular gene. Thus, the values in a row may represent processed data values obtained from one feature of a number microarrays exposed to different tissue samples, or to a time sequence of exposures to a tissue sample. The columns in the RAW_DATA array contain the data obtained from a particular microarray. Thus, in FIG. 10, the rows of the RAW_DATA correspond to particular genes or molecules to which a particular probe of a microarray is targeted, and the columns of the RAW_DATA array correspond to different microarrays, time points, tissue samples or other discrete experiments. As one example, a set of experiments may be employed to address the fluctuations in gene expression levels for a set of genes as an organism is exposed to higher and higher concentrations of a particular toxin. The RAW_DATA array may then be organized so that the expression levels for a particular gene, after exposure of an organism to successively higher concentrations of the toxin, may be read within a row of RAW_DATA in successive cells from left to right.

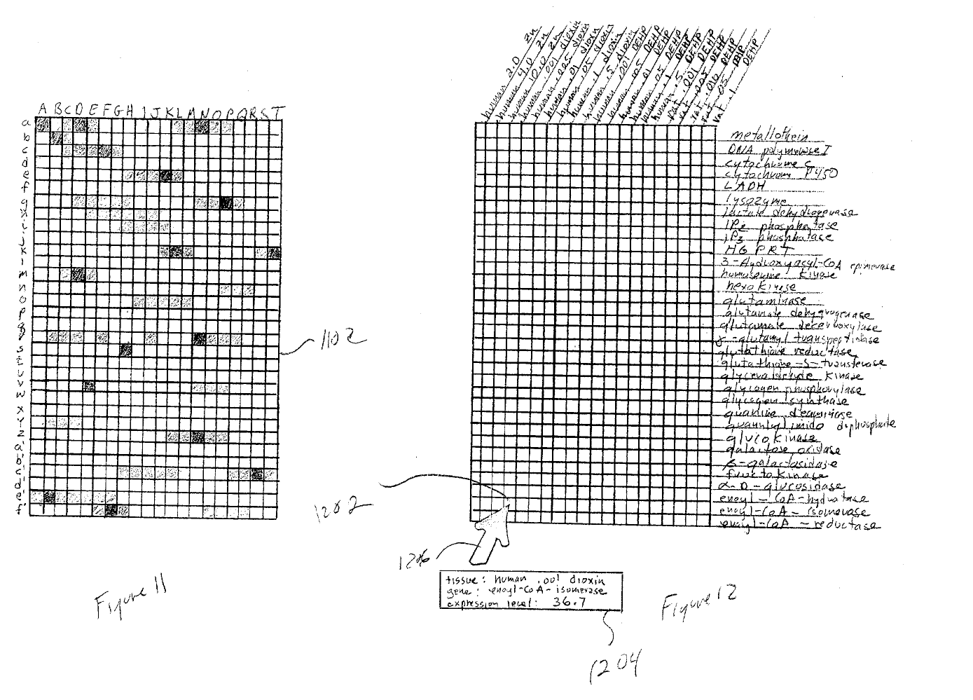

The IUGI that represents one embodiment of the present invention maybe be employed by a researcher or other user to display the contents of the RAW_DATA array on a computer screen. FIG. 11 shows an example display of a 32-row x 20 column RAW_DATA array. The displayed visual data array, 1102, displays a color for each cell in the RAW_DATA array, the colors representing different ranges of numerical values stored within the RAW_DATA array. For example, in the case that the RAW_DATA array displays gene expression values, a range of colors may be selected to represent successive orders of magnitude of the concentration of mRNA transcription products for genes within a tissue sample. The color ranges may alternatively be selected on the basis of less direct, numerical representations of expression levels or expression-level-related values. The displayed expression levels may be absolute expression levels or may be relative expression levels computed with respect to control expression levels for particular genes. Many other types of RAW_DATA values may also be displayed using the IGUI of the present invention. In FIG. 11, the columns are labeled with upper case letters “A”-“T,” and the rows are labeled with lower case letters “a”-“f′.” In this discussion, it is assumed that the columns of the visual data array represent individual experiments, tissue samples, or discrete points in time, and each row contains expression-level values for a particular gene.

Because the RAW_DATA array can be arbitrarily organized from molecular-array data collected from a number of different microarrays, the initial displayed visual data array 1102 maybe already be organized to facilitate visual analysis. For example, the columns for the displayed visual data array may be ordered in time, tissue types, concentration level of a particular toxin, or in some other logical way. Similarly, the rows may be ordered to group more significant genes together within a particular sub-array of the displayed visual data array, or to reflect other types of meaningful orders. However, in general, a researcher or other user cannot initially predict the expression level patterns that result from a series of experiments. Instead, the researcher or other user analyzes the visual data array in order to find expression-level patterns indicative of correlations between different genes or correlations between a particular gene with respect to another variable varied over a series of experiments.

A first visual-aid feature of the IGUI that represents one embodiment of the present invention is that a user may easily display a textual, numerical, or numerical and textual representation of the data contained within a given row, column, or cell of the visual data array. A user may obtain the textual and/or numerical information in several different ways. First, the user may input a mouse click to IGUI buttons or menu selections to turn on the display of row and column labels. Alternatively, a user may position a cursor over a particular cell of the visual data array and input a mouse click in order to display textual and/or numerical information that describes the data displayed in that cell. FIG. 12 illustrates row-based, column-based, and cell-based annotation of the data displayed in a visual data array. In FIG. 12, textual and/or numerical description of the row and columns of a visual data array are displayed to the right, and above, the visual data array, respectively. The specific information describing visual data array cell (31, 4) 1202 is displayed in a small display window 1204 as a result of a user placing cursor 1206 over cell (31,4) 1202 and inputting a mouse click. Many different alternative user inputs may be employed for displaying row and column annotations, removing row and column annotations, displaying cell annotations, and removing cell annotations. A particular IGUI employs one or a small number of input techniques for displaying and removing display of row, column, and cell annotations.

The ability to interactively display textual and/or numerical information concerning the data represented by a row, column, or cell of a graphical data array may greatly facilitate visual analysis of the data. However, in order to analyze the display data for genetic, biochemical, chemical, and other contextual meanings, a researcher or other user needs to interactively modify the display in various logical ways. An extremely useful modification of the display in a visual data array is to reorder columns of the visual data array and to partition the columns into meaningful groups of columns. The IGUI that represents one embodiment of the present invention allows a researcher or other user to arbitrarily reorder and partition columns of the visual data array displayed by the IGUI.

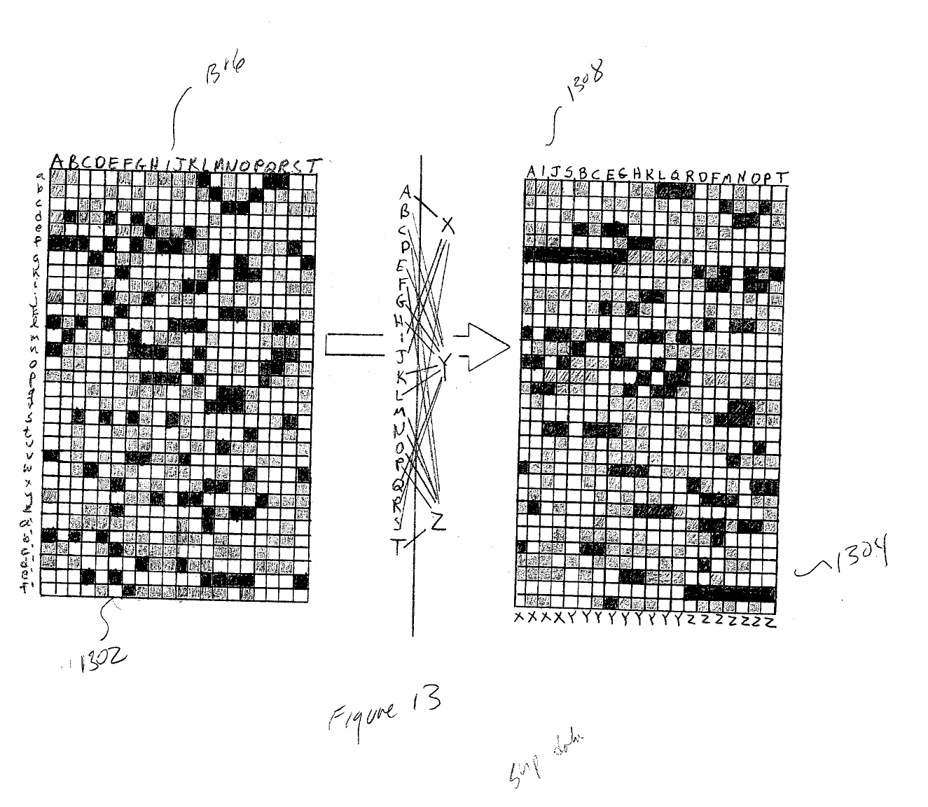

FIG. 13 illustrates column partitioning of the visual data array. In FIG. 13, expression level data is displayed in the visual data array 1302 in one-to-one correspondence with the cells of the RAW_DATA array. As can be seen in FIG. 13, there is no particular pattern discernable from the initial visual data array displayed in 1302. However, the user may partition the columns into three meaningful column subgroups, as shown in FIG. 13, to produce a second visual data array 1304 in which the columns of the initial data array 1302 have been reordered and grouped together into three partitions “X”, “Y”, and “Z.” In FIG. 13, the upper-case letter designations of the columns of the initial visual data array are carried over into the second visual data array 1304. For example, the column in the initial visual data array 1302 that represents experiment “1” 1306 has become the second column 1308 in the partitioned visual data array 1304. Note that the partition labels “X”, “Y”, and “Z” appear below the columns of the partitioned visual data array 1304

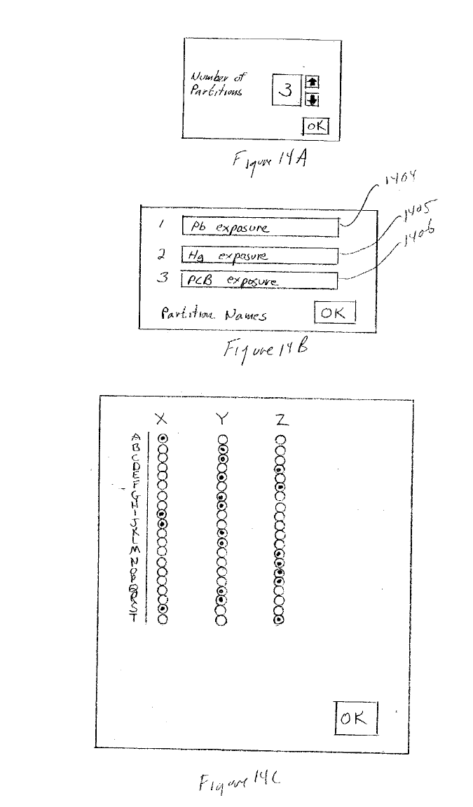

FIGS. 14A-C illustrate one possible user-interface dialogue for partitioning and reordering the columns of a visual data array. First, in FIG. 14A, a user may select the number of partitions desired. Next, in FIG. 14B, a user may input alphanumeric strings into text-input windows 1404-1406 corresponding to each new partition. Finally, in FIG. 14C, a user may select a partition for each column of an initial visual data array in order to partition the columns into groups. By inputting a mouse click into the corresponding circle, a user may, for example, select one of partitions “X,” “Y,” and “Z” for each of columns “A”-“T” of the initial visual data array (1302 in FIG. 13). Many other types of dialogue-box-based conversations may be employed by the IGUI to initiate and control partitioning of graphical data array columns. Note also that the columns may be arbitrarily repartitioned as many times as desired by a researcher or user to interactively search one or more partitioning spaces. Note also that an additional IGUI interface may be employed to turn on and turn off display of one or more partitions of a partitioned visual data array.

Partitioning of a visual data array may greatly facilitate recognition of patterns within the displayed data. For example, referring to FIG. 13, the relatively random-appearing data in the initial visual data array 1302 appears somewhat less random following partitioning into partitions “X,” “Y,” and “Z” in the partitioned visual data array 1304. However, while column partitioning allows for organization along the horizontal axis, interactive organization along the vertical axis may also be needed in order to display data in a way more favorable for pattern recognition. FIG. 15 illustrates row reordering of a visual data array. In FIG. 15, the rows of the partitioned visual data array 1304, previously shown in FIG. 13, are reordered to produce a row-ranked and partitioned visual data array 1502. In FIG. 15, the lowercase row labels are carried from the partitioned visual data array 1304 to the row-ranked and partitioned visual data array 1502, showing the reordering of the rows. Note that a clear pattern is now visible in the row-ranked and partitioned visual data array 1502. In general, genes appears to fall into two different groups. The first group of genes, starting with gene “f” in the top row and including subsequent genes down through gene “o” in row 1504, appear to be up-regulated in the experiments represented by partitions “X” and “Y,” and appear to be down regulated in the experiments represented by partition “Z,” assuming that darker colors in the row-ranked and partitioned graphical data array correspond to higher levels of gene expression. Conversely, the second group of genes, beginning with gene “c′” in row 1506 through gene “e′” in row 1508, appear to be down regulated in the experiments represented by partitions “X” and “Y,” and appear regulated in the experiment represented by “Z.” Thus, by interactively partitioning columns and ranking rows in the initial visual data array (1302 in FIG. 1302), a user or researcher has rearranged the displayed data to produce an easily recognized data pattern with a clear genetic meaning in the context of the experiments from which the data is obtained.

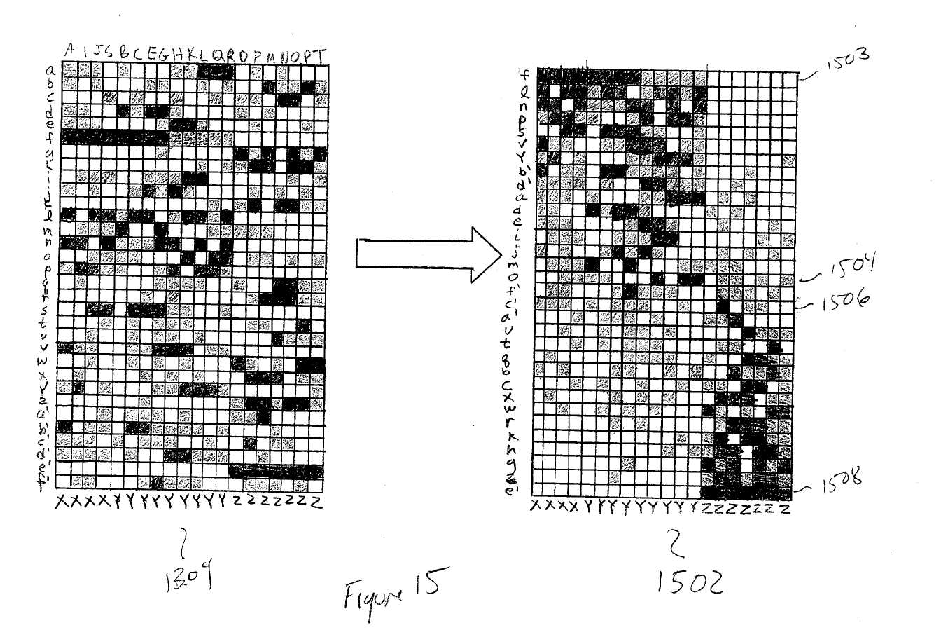

FIG. 16 shows a simple IGUI dialogue box that allows a researcher or other user to reorder rows within a visual data array displayed by the IGUI. In FIG. 16, a user has positioned a cursor 1602 over a displayed name of a row ranking method 1604 in order to highlight the displayed row-ranking method. By then inputting a mouse click to the OK button 1606, the user may interactively reorder the rows within a visual data array according to the selected row-ranking method. For genetic data, for example, many different types of mathematical methods may be used to order rows in terms of correlation of expression levels to partitions. The mathematical techniques used to rank rows depend greatly on the types of experiments and data obtained from the experiments. As one example, a Gaussian-sample-error technique may be used to rank gene expression data for genes with respect to partitions. These various mathematical row-ranking techniques are outside the scope of the present invention. In the illustrated example, a low-ranking method that correlates expression levels to up-regulation in partitions “X” and “Y,” and to down-regulation in partition “Z,” may have been employed.

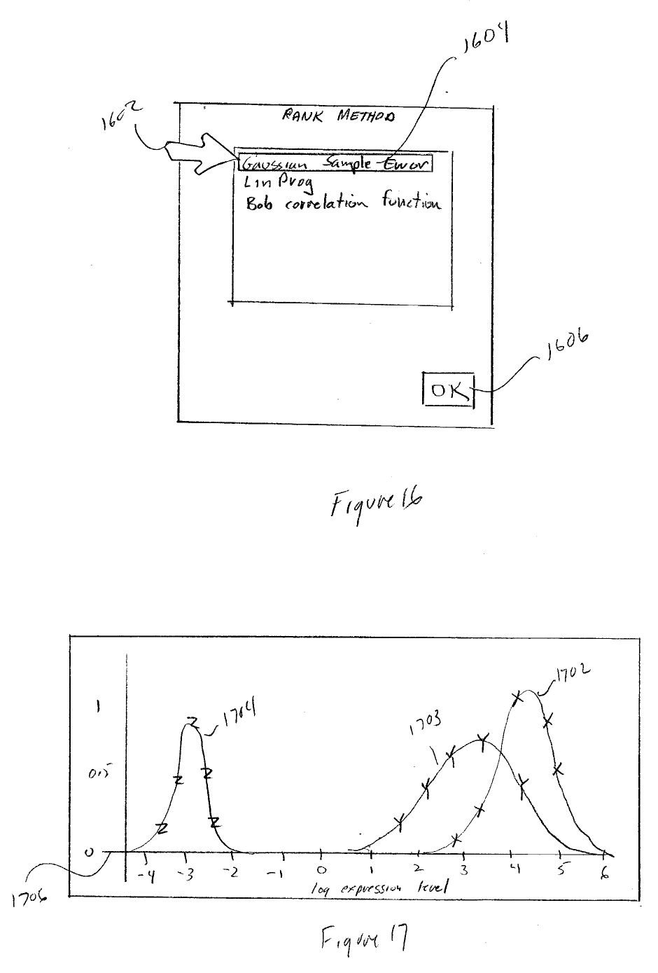

Many of the mathematical low-ranking techniques are based on various types of curve fitting. In those techniques in which curve-fitting techniques are employed a user may input a mouse click to a ranked row in order to display a graphical representation of the curves. For example, FIG. 17 shows display of the curves fit to data for partitions “X,” “Y,” and “Z” for the first row 1503 of the row-ranked and partitioned visual data array 1502 shown in FIG. 15. In the display, the expression levels for each partition, “X,” “Y,” “Z” for gene “f” are fitted to curves 1702-1704, respectively, and plotted along a logarithmic axis 1706. The details of the displayed curve fitting varies with the types of data and the types of mathematical techniques for curve fitting. Alternatively, other methods of row ranking may involve display of other types of graphs or graphical representations of the row-ranking results.

Alternative embodiments of the IGUI may provide for partitioning of rows, in a fashion similar to partitioning of columns. For example, considering SNP genotyping data, it may be useful to partition columns based on groups of individuals, and partition rows so that the data various forms of each SNP lie in adjacent rows. In certain embodiments, the IGUI may also provide a simple input device to allow a user to transpose rows and columns, carry out row or column specific operations, and then again transpose rows and columns, so that row-specific and column-specific operations can be applied to either or both of rows and columns.

Often, a RAW_DATA array may contain thousands or tens of thousands of rows, corresponding to thousands or tens of thousands of genes for which expression levels have been measured in a series of molecular-array experiments. Display of the corresponding visual data array may result in extremely fine lines representing each row. In order to facilitate visual data pattern recognition, a researcher or other user may wish to display only a portion of the rows within the RAW_DATA array. The IGUI that represents one embodiment of the present invention allows a researcher or user to easily alter the visual data array to display a user-determined number of the most significant, or highest-ranked, rows within the array.

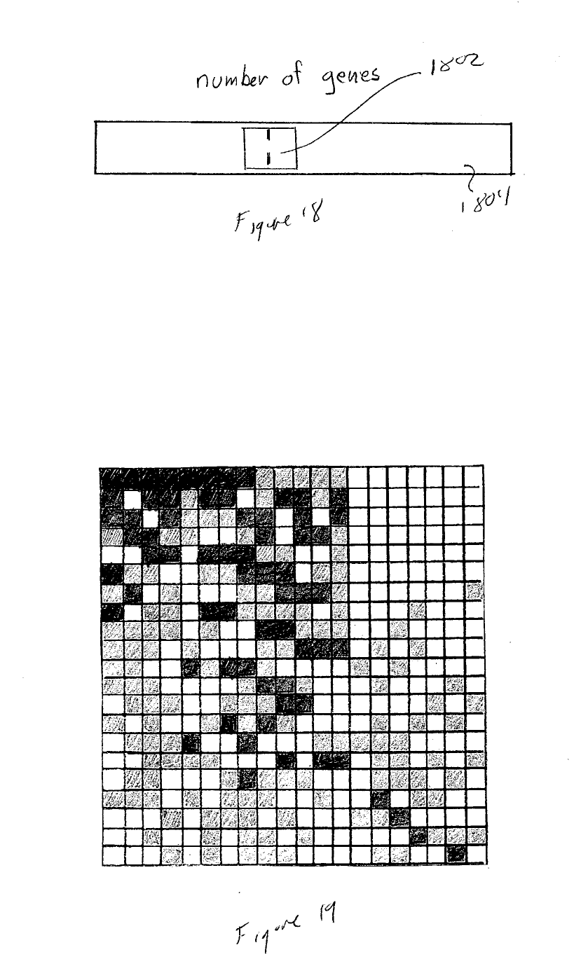

FIG. 18 shows a simple slideable control for altering the number of rows displayed by the IGUI in a visual data array. A user may position a cursor over the slider 1802 to then move the slider, using mouse control, to any horizontal position along the horizontal slider window 1804. When the slider 1802 is positioned to the left of the slider window 1804, all rows of the RAW_DATA array are displayed. When the slider 1802 is positioned to the right of the slider window 1804, only one or a few of the highest, or most significant, rows are displayed. In intermediate positions, the slider control 1802 selects intermediate numbers of most significant rows for display. FIG. 19 illustrates display of the twenty-one most significant rows from the row-ranked and partitioned graphical data array (1502 FIG. 15) according to the intermediate position of the slider control in FIG. 18.

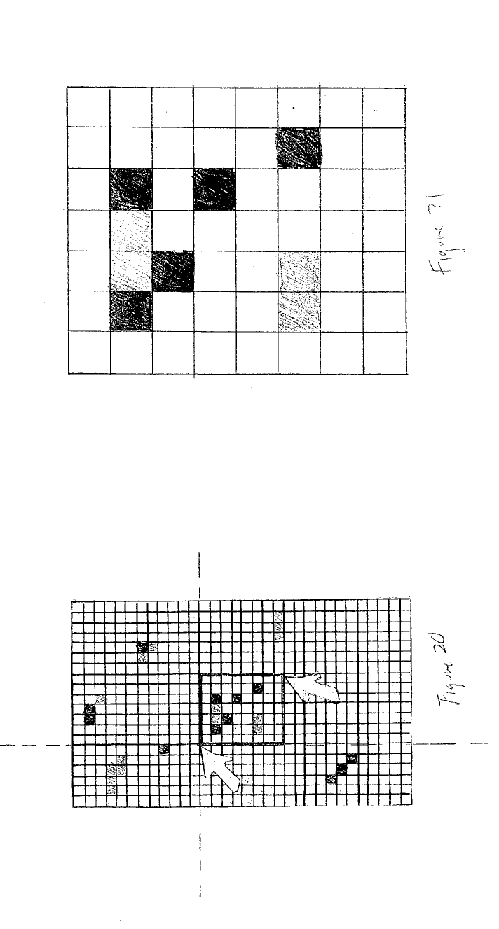

Another feature of the IGUI that represents one embodiment of the present invention is that a user may zoom into, or out from, particular regions of a visual data array displayed by the IGUI. FIG. 20 represents selection by a user of a small region of a graphical data array for display at higher magnification. Following a mouse-click input, the selected region of FIG. 20 is displayed at higher magnification. FIG. 21 shows display of the selected region in FIG. 20 following input of a mouse click. Similarly, a user may zoom out from a selected region to display a larger portion of a visual data array at a lower magnification.

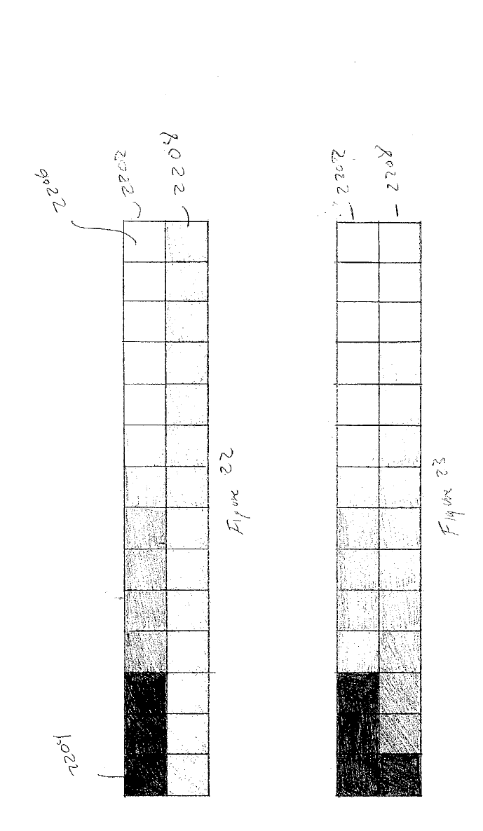

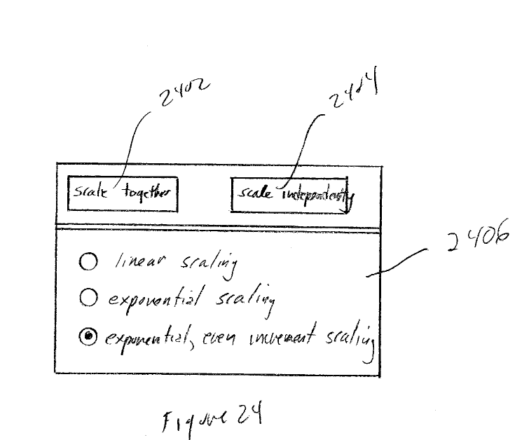

The IGUI that represents one embodiment of the present invention may employ various different mappings of displayed colors in graphical data array cells to numerical data in RAW_DATA array cells. Initially, all rows within a graphical data array may be identically scaled or, in other words, a single, common color-to-data-value scaling may be applied to all rows of the graphical data array. However, use of a single, common scaling technique for all rows may obscure certain data patterns and trends. FIG. 22 shows two adjacent rows within a graphical data array displayed by the IGUI that represents one embodiment of the present invention. The first row 2202 contains sharply contrasting colors, starting from very dark colors on the left such as the dark color displayed in cell 2204, to very light colors on the right, such as the light color displayed in cell 2206. This color contrast within row 2202 reflects data values that span the entire range of expression levels to which colors have been scaled. Row 2208, however, appears uniformly gray. This may be because all data values in the cells of row 2208 are similar or identical, or may also result because variations in the data values of row 2208 are much smaller than the full-scale variations to which all the rows of the graphical data array have been scaled. A user may elect to independently scale each row in the visual data array, so that a full range of colors is employed for the range of data values contained within the cells of each row. FIG. 23 illustrates the same two adjacent rows of the visual data array illustrated in FIG. 22 following individual, row-based resealing of displayed colors. Note that, in FIG. 23, row 2208 now shows a full range of color variations, similar to the full range of color variations shown in row 2202. Individual row-based scaling allows a user or researcher to detect data trends within rows that might be masked by overall scaling of all the rows in a visual data array.

The IGUI that represents one embodiment of the present invention also allows a researcher or other user to select different types of color scaling approaches applied either to the entire array or on a row-by-row basis. A user may, for example, select linear scaling of color over the range of values in an array or row, or may select some other scaling technique, including non-linear scaling better matched to the non-linear visual response of human viewers. FIG. 24 illustrates a simple dialogue box that may be provided by the IGUI to allow a user to select common scaling or row-by-row scaling, and to select different methods for scaling of colors to data values. In FIG. 24, a user may enter a mouse click to the “scale together” button 2402 to scale all displayed data values in the visual data array similarly, or may input a mouse click to the “scale independently” button 2404 in order to scale each row independently, as illustrated in FIG. 23. The scaling technique used may be selected by the user from various options provided in the lower portion of the dialogue box 2406 displayed in FIG. 24.

Although the present invention has been described in terms of a particular embodiment, it is not intended that the invention be limited to this embodiment. Modifications within the spirit of the invention will be apparent to those skilled in the art. For example, an IGUI embodiment of the present invention may be implemented in any of many different programming languages to run on any of many different types of computer systems running any of many different types of operating systems. The IGUI may be implemented in a practically limitless number of different ways, including different modular organizations, different control structures, different variables and variable names, and different data structures. While the disclosed embodiment related to visual display of molecular-array-derived data, similar data derived from other experimental techniques in other technical and scientific fields may also by displayed using alternative embodiments of the IGUI. In the disclosed embodiment, a row-and-column display paradigm is employed, but alternate organization methods may also be employed. In the disclosed embodiment, columns are partitioned and rows are ranked, but, in alternative embodiments, rows may be partitioned and columns ranked, or both rows and columns may be ranked and partitioned. Many different data-to-color mappings, ranking formulas, partitioning tools, and interactive input and dialogue techniques may be employed. The disclosed embodiment represents a single example using a few of many possible alternatives for ranking, partitioning, scaling, and user/visual display interaction. Most importantly, as discussed above with reference to FIGS. 9A-F, the techniques of the present invention may be applied to any of the many types of genetic, biological, biochemical, and chemical data amenable to two-dimensional display.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A user interface for displaying data derived from one or more microarray experiments, the user interface comprising:
a visual data array that displays color-coded representations of data obtained from scanning one or more microarrays;
a partitioning control that responds to input partitioning directives to partition microarray data into two or more partitions for display in the visual data array; and
a ranking control that responds to input ranking-technique selections by carrying out a selected ranking technique to order microarray data for display in the visual data array.

2. The user interface of claim 1 wherein the visual data array displays a 2-dimensional grid comprising rows and columns of color-coded cells, each cell representing a discrete data value derived from a microarray.

3. The user interface of claim 2 wherein a discrete data value may represent a biological, genetic, or chemical quantity or result, including:
an expression-level of a gene in a biological sample;
a concentration of a biopolymer in a sample;
a concentration of a chemical substance in sample solution;
a relative concentration of two chemical substances in a sample solution; and
a relative concentration of two biopolymers in a sample.

4. The user interface of claim 2 wherein each row contains data related to a particular type of probe included in a series of microarray, and each column contains data extracted from a particular microarray.

5. The user interface of claim 2 wherein a row represents a particular gene, protein, or other biological molecule, and a column represents data extracted from a particular microarray.

6. The user interface of claim 2 wherein the partitioning control responds to input partitioning directives to partition columns of the visual data array into column partitions.

7. The user interface of claim 2 wherein the ranking control responds to input ranking-technique selections by carrying out the selected ranking technique to order rows within the visual data array.

8. The user interface of claim 1 further including:
a data selection control that responds to input selection directives to select a subset of microarray data for display in the visual data array.

9. The user interface of claim 8 wherein the data selection control that responds to input selection directives to select a most significant set of rows for display in-the visual data array.

10. The user interface of claim 8 wherein the data selection control is a slider within a horizontal window that can be moved from a left-most position, at which all rows are selected for display, to a right-most position, at which only one or a few rows are selected for display, through intermediate positions at which intermediate numbers of rows are displayed.

11. The user interface of claim 1 further including:
a color-to-data scaling control that responds to input color-scaling directives to either generally scale display color to all of the microarray data displayed in the visual data array or to scale display color separately for subgroups of displayed microarray data.

12. The user interface of claim 1 further including:
a color-to-data scaling control that responds to input color-scaling directives to apply a selected color-scaling technique to map microarray data to colors.

13. The user interface of claim 1 further including:
an annotation control that responds to input commands to display textual information related to microarray data displayed in the visual data array.

14. The user interface of claim 13 wherein one or more annotation controls allow for displaying textual information related to columns, rows, and cells within the visual data array.

15. The user interface of claim 1 further including:
a graphical ranking display control that responds to input commands to display curves fitted to microarray data in order to determine data rankings.

16. The user interface of claim 1 further including:
a magnification control that responds to input commands to zoom into, or zoom out from, regions of the visual data array.

17. A method for displaying microarray data on a display device, the method comprising:
mapping the microarray data to a range of colors;
displaying a visual data array that displays a color corresponding to a discrete microarray data value;
providing a partitioning control that responds to input partitioning directives to partition microarray data into two or more partitions for display in the visual data array; and
providing a ranking control that responds to input ranking-technique selections by carrying out a selected ranking technique to order microarray data for display in the visual data array.

18. The method of claim 17 wherein the visual data array displays a 2-dimensional grid comprising rows and columns of color-coded cells, each cell representing a discrete data value derived from a microarray.

19. The method of claim 18 wherein a discrete data value may represent a biological, genetic, or chemical quantity or result, including:
an expression-level of a gene in a biological sample;
a concentration of a biopolymer in a sample;
a concentration of a chemical substance in sample solution;
a relative concentration of two chemical substances in a sample solution; and
a relative concentration of two biopolymers in a sample.

20. The method of claim 18 wherein each row contains data related to a particular type of probe included in a series of microarray, and each column contains data extracted from a particular microarray.

21. The method of claim 18 wherein a row represents a particular gene, protein, or other biological molecule, and a column represents data extracted from a particular microarray.

22. The method of claim 18 wherein the partitioning control responds to input partitioning directives to partition columns of the visual data array into column partitions.

23. The method of claim 17 wherein the ranking control responds to input ranking-technique selections by carrying out the selected ranking technique to order rows within the visual data array.

24. The method of claim 17 further including:
providing a data selection control that responds to input selection directives to select a subset of microarray data for display in the visual data array.

25. The method of claim 24 wherein the data selection control that responds to input selection directives to select a most significant set of rows for display in the visual data array.

26. The method of claim 24 wherein the data selection control is a slider within a horizontal window that can be moved from a left-most position, at which all rows are selected for display, to a right-most position, at which only one or a few rows are selected for display, through intermediate positions at which intermediate numbers of rows are displayed.

27. The method of claim 17 further including:
providing a color-to-data scaling control that responds to input color-scaling directives to either generally scale display color to all of the microarray data displayed in the visual data array or to scale display color separately for subgroups of displayed microarray data.

28. The method of claim 17 further including:
providing a color-to-data scaling control that responds to input color-scaling directives to apply a selected color-scaling technique to map microarray data to colors.

29. The method of claim 17 further including:
providing an annotation control that responds to input commands to display textual information related to microarray data displayed in the visual data array.

30. The method of claim 29 wherein one or more annotation controls allow for displaying textual information related to columns, rows, and cells within the visual data array.

31. The method of claim 17 further including:
providing a graphical ranking display control that responds to input commands to display curves fitted to microarray data in order to determine data rankings.

32. The method of claim 17 further including:
providing a magnification control that responds to input commands to zoom into, or zoom out from, regions of the visual data array.

33. A user interface for displaying experimentally derived data that can be organized as a two-dimensional display, the user interface comprising:
a visual data array that displays color-coded representations of the data;
a partitioning control that responds to input partitioning directives to partition the data into two or more partitions for display in the visual data array; and
a ranking control that responds to input ranking-technique selections by carrying out a selected ranking technique to order the data for display in the visual data array.

34. The user interface of claim 33 wherein the visual data array displays a 2-dimensional grid comprising rows and columns of color-coded cells, each cell representing a discrete data value.

35. The user interface of claim 33 wherein the partitioning control responds to input partitioning directives to partition columns of the visual data array into column partitions.

36. The user interface of claim 33 wherein the ranking control responds to input ranking-technique selections by carrying out the selected ranking technique to order rows within the visual data array.

37. The user interface of claim 33 wherein the partitioning control responds to input partitioning directives to partition rows of the visual data array into row partitions.

38. The user interface of claim 33 wherein the ranking control responds to input ranking-technique selections by carrying out the selected ranking technique to order columns within the visual data array.

39. The user interface of claim 33 further including:
a data selection control that responds to input selection directives to select a subset of the data for display in the visual data array.

40. The user interface of claim 39 wherein the data selection control is a slider within a horizontal window that can be moved from a left-most position, at which all rows are selected for display, to a right-most position, at which only one or a few rows are selected for display, through intermediate positions at which intermediate numbers of rows are displayed.

41. The user interface of claim 33 further including:
a color-to-data scaling control that responds to input color-scaling directives to either generally scale display color to all of the data displayed in the visual data array or to scale display color separately for subgroups of displayed data.

42. The user interface of claim 33 further including:
a color-to-data scaling control that responds to input color-scaling directives to apply a selected color-scaling technique to map data to colors.

43. The user interface of claim 33 further including:
an annotation control that responds to input commands to display textual information related to data displayed in the visual data array.

44. The user interface of claim 43 wherein one or more annotation controls allow for displaying textual information related to columns, rows, and cells within the visual data array.

45. The user interface of claim 33 further including:
a magnification control that responds to input commands to zoom into, or zoom out from, regions of the visual data array.

46. A method for displaying biological, genetic, biochemical, and/or chemical data on a display device, the method comprising:
mapping the data to a range of colors;
displaying a visual data array that displays a color corresponding to a discrete data value;
providing a partitioning control that responds to input partitioning directives to partition the data into two or more partitions for display in the visual data array; and
providing a ranking control that responds to input ranking-technique selections by carrying out a selected ranking technique to order the data for display in the visual data array.
